(19) United States
(12) Patent Application Publication
(10) Pub. No.: US 2001/0038232 A1
(43) Pub. Date: Nov. 8, 2001

(54) LOW PRESSURE IN MOLD LAMINATION INJECTION MOLDED SUNSHADE

(76) Inventor: JOHN M. YERA, BRIGHTON, MI (US)

Correspondence Address: ANDREW R BASILE, YOUNG AND BASILE, 3001 WEST BIG BEAVER ROAD SUITE 624, TROY, MI, 48084

(21) Appl. No.: 09/281,585

(22) Filed: Mar. 30, 1999

(51) Int. Cl. B62D 25/06; B60J 7/00

(52) U.S. Cl. 296/214; 296/39.1

(57) ABSTRACT

A sunshade assembly for a vehicle comprising a molded frame having a center open area. The frame having two lateral rails, a front rail, and a rear rail. An integrally molded handle attached to the front rail extends partially into the center open area. One or more support bars may be integrally molded to at least two of the handle and rails. For a sunshade assembly used as an original equipment item, the frame with or without support bars may be integrally molded and bonded to an outer covering material simultaneously by means of low pressure injection molding and in-mold lamination.

### FIELD OF THE INVENTION

This invention relates to a covered sunshade panel for a sunroof for a vehicle, such as cars, trucks, sport utility vehicles, vans etc.

### BACKGROUND OF THE INVENTION

Conventionally, vehicle sunroofs have been mounted in a roof of a vehicle such that the sliding roof member made of glass, synthetic resin, or the like could be moved forwardly and rearwardly to open and close the opening in the roof. The sunshade panel is provided to protect against environmental elements such as solar radiation. The sunshade panel must be of a light weight construction so that it does not add unneeded weight to the vehicle, and at the same time provide the strength and durability to maintain its shape and does not distort during opening and closing of the sunroof assembly

In the constant strive to reduce cost by the automobile manufacturers, but at the same time providing the customer with all the amenities that he has become accustomed to, certain areas of the vehicle are investigated for possible re-design thereby providing cost saving. Previous sunroof assemblies provided a rigid molded; sunshade structure having a rectangular shape and a small indentation to provide for a pull handle at the front of the sunshade structure. A cloth fabric, vinyl, woven, or screen like material would then be attached to an underside of the panel by means of glue or other similar appropriate means to attach the material to the panel. The material was installed as a second step to match the interior of the vehicle.

### SUMMARY OF THE INVENTION

It is a primary object of the present invention to simplify the manufacturing process of the sunshade, reduce material cost of the sunshade assembly by eliminating the rigid solid panel structure of the sunshade and instead utilize integrally molded support bars within a frame which outlines the sunshade contour.

The current invention provides two levels of assembly for a cost efficient sunshade assembly. One level of assembly is mainly for use as original equipment to the automobile manufacturer. Another level of assembly is used primarily for the aftermarket automotive business. The aftermarket client prefers to receive a sunshade assembly without any covering attached. The aftermarket client provides a sunshade that matches a myriad of automobile models and interiors. Therefore, the sunshade frame provided for the aftermarket is a frame configuration with a handle integrally molded to the front frame piece for opening and closing the sunroof assembly. Further included may be one or more support bars that are integrally molded with the sunroof frame. The support bars provide enough strength to the frame such that a solid panel is not required. The frame is later attached to an appropriate material covering to match a given vehicle's interior by the aftermarket dealers.

The original equipment manufacturers requires the sunshade assembly with the cloth covering fully assembled to the frame. This simplifies a portion of the vehicle assembly. The sunshade assembly for the original equipment manufacturer includes the frame as configured for the aftermarket purchaser, but further includes a covering fabric that is laminated to the frame structure during the low pressure in mold lamination injection molding of the frame. Therefore, the material is attached to the frame in a one step process that eliminates the necessity of hand wrapping, trimming and assembly which translates into cost savings.

The sunshade assembly of the aforementioned configurations provide the advantages of using less plastic as currently used but yet providing a durable structure for the sunshade. Because of the less plastic material being used, a cost savings is the net result. Now there are reduced cycle times which translates into better machine utilization and lower cost.

Other objects, advantages and applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is an exploded view of a rigid sunshade frame and an outer covering material (not preformed) before attachment thereof;

FIG. 2 is a perspective view of a sunshade frame integrally molded to the outer covering material to form a sunshade assembly positioned in a sunroof opening of a vehicle;

FIG. 3 is a partial view of the sunshade assembly taken along lines 3-3 of FIG. 2;

FIG. 4 is a perspective view of a sunshade assembly having a second embodiment for the frame;

FIG. 5 is a perspective view of a sunshade assembly having a third embodiment for the frame;

FIG. 6 is a partial view of a fourth embodiment for the sunshade frame of FIG. 5 showing a variation about the handle;

FIG. 7 is a partial view of a fifth embodiment for the sunshade frame configuration for the sunshade assembly;

FIG. 8 is a view of a robot loading fabric material into an injection mold;

FIG. 9 is a partial view of a robot positioning the fabric material in the mold;

FIG. 10 is a partial view of the fabric material being loaded onto a retainer pin in the mold;

FIG. 11 is a view of the fabric material after loading onto the retaining pins in the mold;

FIG. 12 is a partial view after the core and the cavity of the mold is shut.

FIG. 13 is a partial view of the slide body of the mold as it moves the fabric material down onto the retainer pin.

FIG. 14 is a perspective view of the finished sunshade assembly shown on the retainer pins;

FIG. 15 is a partial view of a finished injection molded sunshade being moved from a cavity by a straight lifter; and

FIG. 16 is a view of the robot removing the sunshade assembly from the mold.

### DESCRIPTION OF THE PREFERRED EMBODIMENT

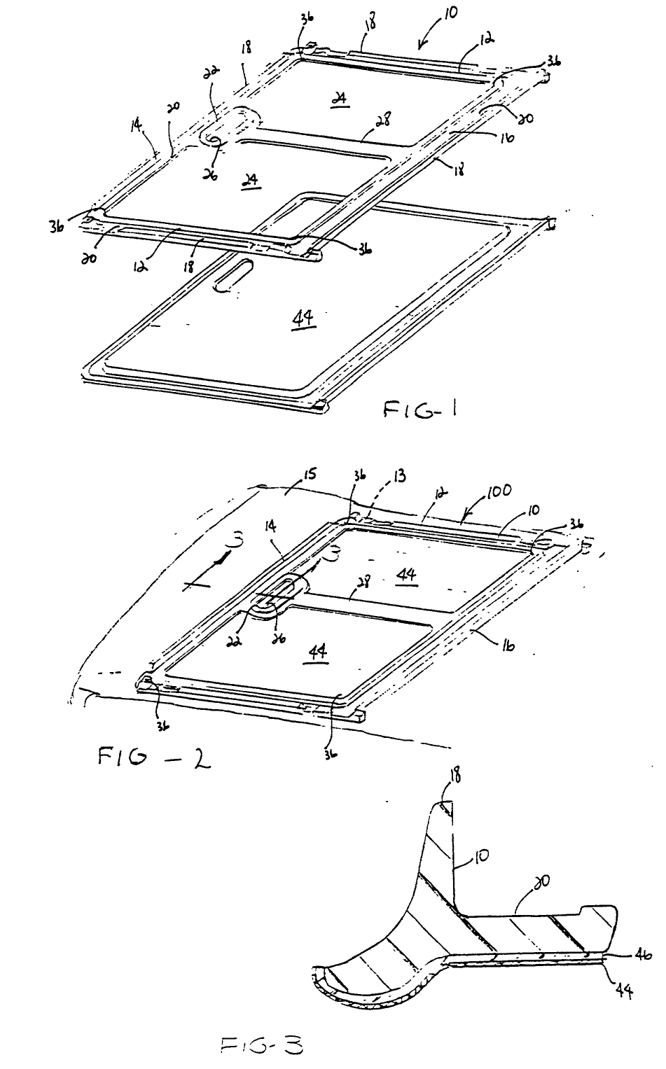

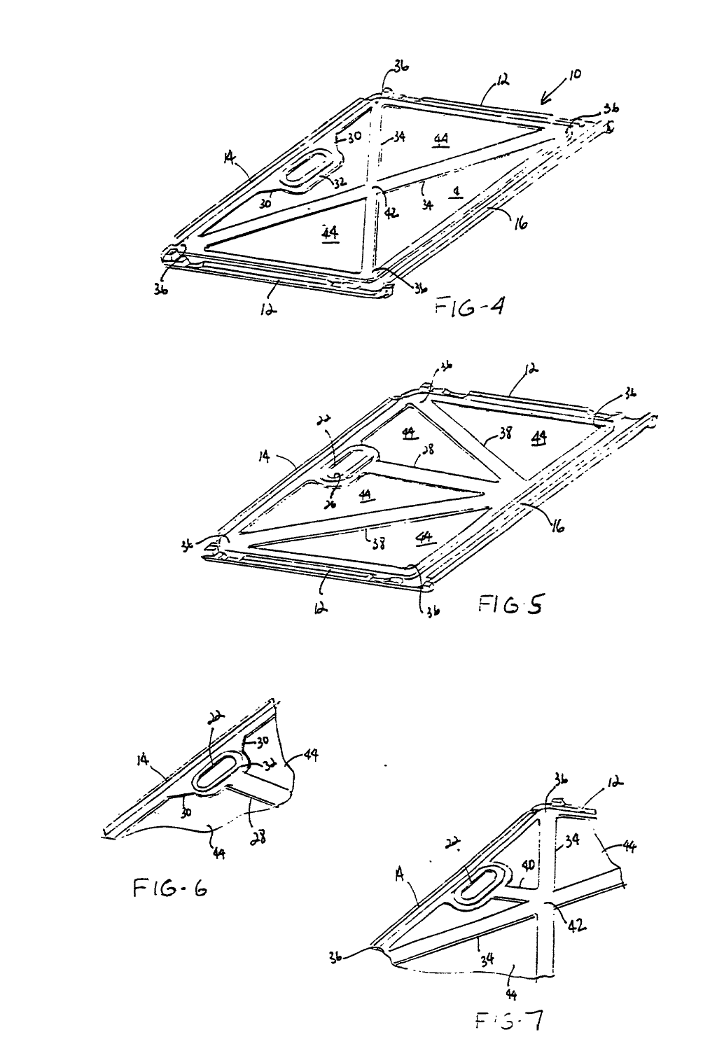

Looking at the figures and especially FIGS. 1-7, there are shown various configurations of a sunshade frame for use to be integrally molded with a fabric material cover during the molding process or for later attachment to the fabric material by conventional means as preferred in the aftermarket industry. Each frame 10 is a single member which includes a pair of lateral members 12 which are configured for lateral sliding within a sunroof opening 13 of a vehicle 15. The frame 10 further includes a front member 14 and a rear rail 16. The front member 14 and rear member 16 as well as the lateral member 12 may each contain strengthening ribs 18 and grooves 20 according to the specification of the automotive manufacturer. Between the four members is a generally open area 24 spanning from one member to the opposing member. A handle 22 integrally molded to the front member 14 may extend partially into the open area 24 of the frame 10. The handle 22 provides a through hole 26 or indentation in which fingers or a hand or addition of a separate pull handle may be extended therein to slide the sunshade assembly within the roof opening 13. The greatest amount of stress to the frame 10 occurs at the handle 22, therefore it is preferred to utilize a configuration that reinforces the handle 22 and front rail 14. As shown in FIG. 1, a support bar 28 may extend laterally and parallel with the lateral member 12 from the handle 22 to the rear member 16. In another embodiment, as shown in FIG. 4, if no support bar 22 extends from the handle 22 to the rear rail 16, it is preferred to provide extra support around the handle 22 such as having angular flanges 30 extending from the handle 22 to the front member 14. As shown in FIG. 6 the handle 22 may include both the angular flanges 30 extending from the rearmost portion 32 of the handle 22 to the front member 14 as well as a lateral support bar 28 extending from the handle 22 to the rear member 16.

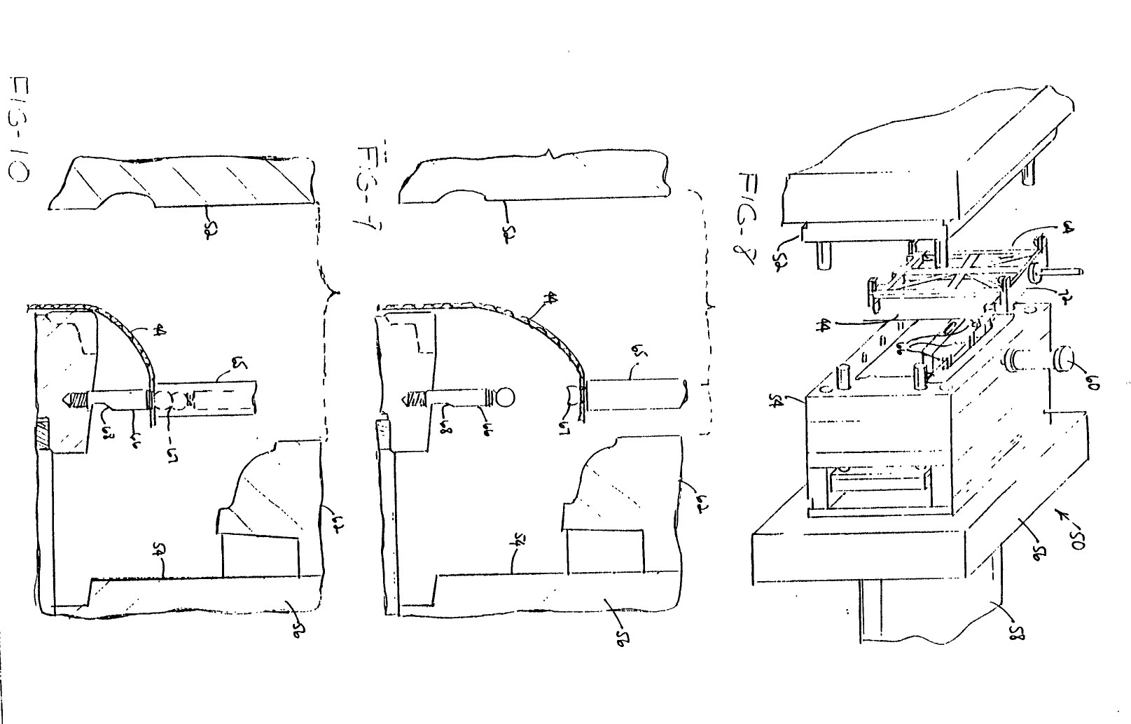

To provide added strength to the two lateral members 12 and eliminate or minimize torsional stress on the frame 10, diagonal support bars or members 34 may be provided that extend between at least a pair of diagonal corners 36 and preferably between all four corners 36 of the frame 10. FIG. 4 shows diagonal support bars 34 extending from each corner to its opposing diagonal corner 36. FIG. 5 shows an alternative use of diagonal bars wherein the diagonal bars 38 are integrally molded to corners 36 of the front member 14 and extend to the center support bar 28 at the rear member 16. FIG. 7 also shows a partial lateral support bar 40 extending from the handle 22 to the cross portion 42 formed by the two diagonal members 34. This configuration adds strength to the four peripheral members 12, 14 and 16 of the frame, and in addition it adds support to the handle 22. One or more of the aforementioned configurations for the sunshade frame 10 may be preferred on a specific make and model vehicle. The size of the opening in the roof along with the size of the vehicle will dictate the amount of support required for the sunshade frame 10 and its handle 22. Ultimately, it is one intent of the invention to use a minimum amount of plastic material for the sunshade assembly without sacrificing strength and durability.

The sunshade frame 10 may be supplied to the aftermarket dealer alone and separate from the material 44 as shown in FIG. 1. The aftermarket dealer can then attach the molded frame 10 to a fabric material 44 by conventional means. The fabric material 44 may be any cloth, vinyl, leather, screen, etc. material that can be attached along the periphery of the frame 10 to close or cover the open area 24 to provide the sunshade. Further, the material 44 may include a foam layer 46 for cushioning and aesthetic considerations. In many instances the aftermarket dealer will prefer a separate plastic molded frame 10 for later installation and connection with material which matches the many various models and makes of vehicles in which his business handles.

The original equipment manufacturer requires that the fabric material 44 is integrally connected to the frame 10. The sunshade assembly 100 with the frame 10 and fabric material 44 as an integral unit is shown in FIG. 2. The sunshade assembly 100 is manufactured by molding the fabric material 44 to the plastic frame 10 during the molding process. The fabric material 44 is thus fused or laminated to the frame, support, and handle surfaces This process eliminates the necessity to attach the fabric material 44 to the frame by other means, thereby eliminating unnecessary labor.

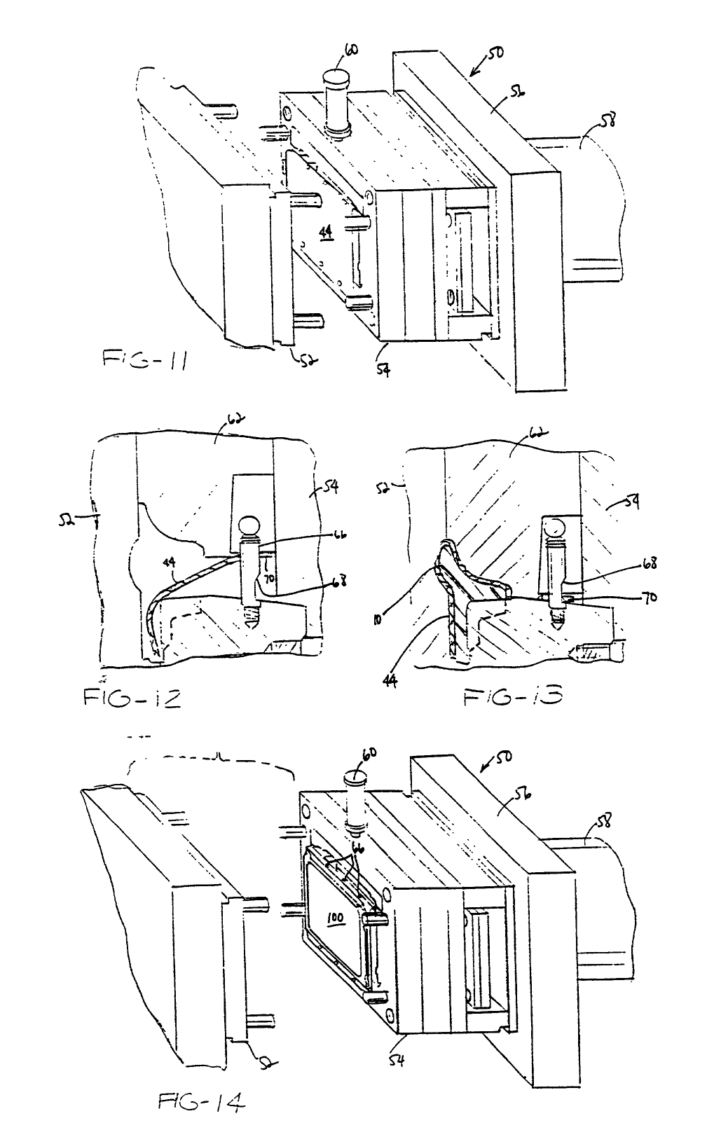

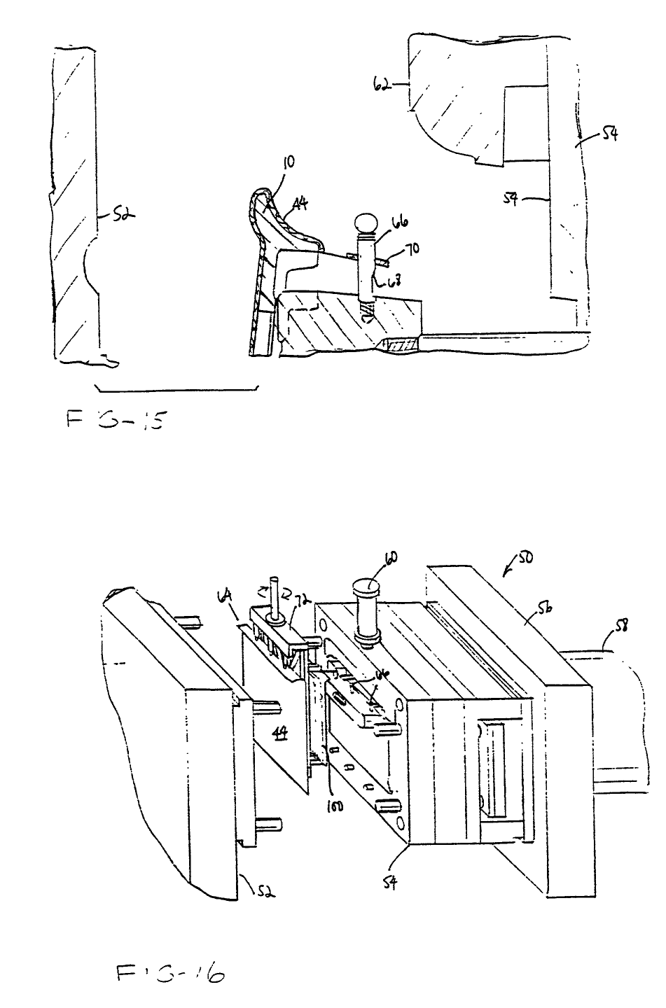

FIGS. 8-16 show the series of steps for rendering a low pressure in mold lamination injection molded sunshade having a frame 10 integrally molded to a cloth member 44. The cloth member 44 may include a single layer of material or may include a foam layer 46 placed adjacent the fabric material 44. The mold 50 is a conventional machine having a core side 52 and a cavity side 54. A stationary platen 56 is connected to an injection barrel 58 through which plastic fluid enters into the cavity side 54 of the mold 50. Valve gates (not shown) are used to control the fluid into the cavity 54. A hydraulic cylinder 60 is used to move a slide body 62 of the mold 50 into the cavity chamber. The shade body 62 is partially shown in FIG. 9. A robot 64 moves a precut piece of fabric material 44 in alignment with the injection mold cavity 54. In FIG. 9, the robot 64 end of arm tooling is attached to the material 44 and moves the material 44 into engagement with the retainer pin 66 of the mold cavity 54. The retainer pin 66 is notched 68 so that the material 44 can move slightly during the molding process. In FIG. 10, the robot arm 65 has an end piece 67 which engages the returning pin 66 to load the material 44 onto the mold cavity 54. FIG. 11 shows the cloth material 44 once it is loaded onto the retainer pins 66 in the mold 50. In FIG. 12 the core side 52 and the slide body 62 of the cavity side 54 of the mold 50 closes and the slide body 62 moves the material 44 down onto the retainer pin 66. FIG. 13 shows a partial view of the material 44 and plastic material after the molding process. The retainer pin 66 is still attached to an end portion 70 of a fabric material 44. The retainer pin 66 has clearance to allow the material 44 to shift and stretch during the molding process. When the core side 52 opens the cavity of the mold 50, the finished sunshade 100 remains held onto the retainer pins 66 as shown in FIG. 14. FIG. 15 shows a partial view of the finished part when the cavity of the mold 50 is opened. The robot 64 then moves the finished sunshade 100 away from the mold 50 and prepares to load the material 44 for the next sunshade unit. The robot 64 has a rotatable end of arm tooling 72 for holding a finished sunshade 100 on one side of the end of arm tooling 72 while introducing the new material 44 from the other side of the plate.

From this process, the material 44 is integrally molded to the sunshade frame 10 in one step. The result is a sunshade 100 that is a light weight assembly which saves manufacturing time as well as material cost and weight to the final assembly.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A sunshade assembly for an opening in a roof of a vehicle comprising:
a molded frame having peripheral edges sized for mounting within the opening in the roof and having a through open portion between the peripheral edges, said peripheral edges including a pair of lateral members, a front member, and a rear member, wherein all said members are integrally connected.

2. The sunshade assembly of claim 1 further including a laterally projecting handle integrally fixed to the front member, wherein said handle projects into the open portion of the frame.

3. The sun shade assembly of claim 2 further including a laterally projecting support integrally connected to the handle and extending to the rear member.

4. The sunshade assembly of claim 2, wherein the front member and rear member are connected to the lateral members at corners, said sunshade assembly having diagonal supports extending through the open portion of said frame and integrally connected to the frame at the corners.

5. The sunshade assembly of claim 2 wherein the handle has angular flanges extending away from said handle to the front member.

6. The sunshade assembly of claim 4, wherein said diagonal members define a cross in the approximate center of said open portion, said sun shade assembly further including a laterally projecting support integrally connected to the handle and extending to the cross.

7. The sunshade assembly of claim 3, further comprising diagonal supports extending from the corners adjacent to the front member at one end and integrally fixed to the laterally projecting support adjacent to the rear member at the other end.

8. The sunshade assembly for an opening in a roof of a vehicle comprising:
a frame member formed of molded plastic material having peripheral edges sized for mounting within the opening in the roof and having a through open portion between the peripheral edges including a pair of lateral members, a front member, and a rear members, and
an outer covering material molded to the plastic material to adhere said covering material to said frame.

9. The sunshade assembly of claim 8 further including a laterally projecting handle integrally molded to the front member and a portion of the outer covering material, wherein said handle projects into the open portion of the frame.

10. The sunshade assembly of claim 9 further including a laterally projecting support integrally molded and connected to the handle and another portion of the outer covering material, said support extending to the rear member.

11. The sunshade assembly of claim 9 further including angular flanges extending away from said handle and integrally molded to another portion of the outer covering material.

12. The sunshade assembly of claim 9 wherein the front member and rear member are integrally connected to the lateral member at corners, and wherein the frame further includes at least one diagonal support member integrally molded to one of the corners and extending across the open portion.

13. The sunshade assembly of claim 12, wherein another portion of the outer covering material is molded to at least one diagonal support member.

14. The sunshade assembly of claim 8, wherein the outer covering material includes more than one layer of covering material.

15. The sunshade assembly of claim 14, wherein at least one layer of covering material is foam.

16. A method for assembling a sunshade assembly comprising the step of:
molding a fabric material to a sunshade frame during the molding process of the frame, said frame forming the peripheral edges of the sunshade assembly having an open center area within the peripheral edges and the fabric material extending to and molded to the peripheral edges to cover the open center area of the frame.
